(19) United States
(12) Patent Application Publication
(10) Pub. No.: US 2014/0147362 A1
(43) Pub. Date: May 29, 2014

(54) Shift Catalyst, Gas Purification Method and Equipment of Coal Gasifier Plant

(71) Applicant: Hitachi, Ltd., Tokyo (JP)

(72) Inventors: Takashi SASAKI, Tokyo (JP); Tomoko AKIYAMA, Tokyo (JP)

(73) Assignee: Hitachi, Ltd., Tokyo (JP)

(21) Appl. No.: 14/081,421

(22) Filed: Nov. 15, 2013

(30) Foreign Application Priority Data
Nov. 28, 2012 (JP) 2012-259423

(51) Int. Cl. B01J 23/883; C01B 3/58

(52) U.S. Cl. CPC B01J 23/883; C01B 3/583
USPC 423/247; 422/162; 502/309

(57) ABSTRACT

A gas purification method is disclosed for a coal gasifier plant, with which energy loss accompanying recovery of CO₂ can be suppressed and soundness of a CO shift catalyst can be maintained in the plant. The method includes a scrubbing step for a product gas produced by gasification of a carbon-containing solid fuel and containing at least CO and H₂S to remove water-soluble substances contained in the product gas; a CO shift step to react CO in the product gas after scrubbing with steam using a shift catalyst and converting the gas into CO₂ and H₂; and a CO₂/H₂S recovery to remove CO₂ and H₂S from the product gas after the CO shift step, wherein the CO shift step is constituted by a multistage shift reactor which includes multiple stages of shift reactors, and shift reactors upstream and downstream have high- and low-temperature shift catalysts, respectively.

### BACKGROUND OF THE INVENTION

1. Field of the Invention

The present invention relates to a shift catalyst, which converts CO in a product gas produced by gasification of coal into CO₂ in the presence of H₂S, and also relates to a gas purification method and a gas purification equipment of a coal gasifier plant, with which CO is efficiently converted into CO₂ and H₂ using the catalyst.

2. Background Art

A lot of thermal electricity generation plants for generating electricity using a fuel such as coal, petroleum, or a natural gas have been conventionally operated. Among these, a technique relating to an Integrated Coal Gasification Combined Cycle (IGCC), in which coal whose reserves is high and therefore enabling stable supply also in future is used as a fuel, and coal in a gasifier is first gasified, and then, a product gas produced by the gasification of the coal is used as a fuel for generating electricity has attracted attention recently.

Further, amid concerns that resources such as petroleum and natural gases are depleted, there has been a growing need for a plant that produces a chemical product, which has conventionally been produced from petroleum or a natural gas, from coal. A coal gasifier plant has been used not only for generating electricity, but also for producing H₂ to be used as a starting material of a chemical product.

Recently, a technique for recovering CO₂ for reducing CO₂ emission from a plant that emits CO₂ has been developed from the viewpoint of prevention of global warming.

Japanese Patent Nos. 2870929 and 3149561 each disclose a technique relating to a coal gasifier electricity generation plant, in which a sulfur component of H₂S or COS contained in a product gas from a gasifier is removed by a desulfurization equipment, and thereafter, by a shift reactor, CO in this product gas is converted into CO₂ and H₂ through a shift reaction represented by the formula (1), and CO₂ in the gas is recovered by a CO₂ recovery equipment.

CO+H₂O→CO₂+H₂ (1)

Further, also in a coal gasifier plant for producing a chemical product, a similar process for converting CO in a gasified gas into CO₂ and H₂ through a shift reaction is adopted for obtaining high-purity H₂ to be used as a starting material.

As a catalyst for promoting the shift reaction, for example, a Cu—Zn-based catalyst was published from Girdler, Ltd Inc. and DuPont Co., in the 1960s, and heretofore has been widely used as a catalyst or the like mainly for the above-described plant.

The above-described catalyst exhibits shift performance to convert CO into CO₂ in a low temperature range of 300° C. or lower. Further, as a catalyst which can be used in a high temperature range of 300° C. or higher, a Fe—Cr based catalyst is known and used in the above-described plant along with the above-described low temperature shift catalyst.

These catalysts are all known to be poisoned by a sulfur component. In the above-described coal gasifier plant as a known example, a small amount of a sulfur component is contained in the gasified product gas, and therefore, when the above-described catalyst is used, it is necessary to perform a desulfurization operation before the catalyst is allowed to act. Therefore, the Cu—Zn-based catalyst or the Fe—Cr based catalyst is called “sweet shift catalyst”.

Since the shift reaction in a shift reactor is an exothermic reaction, the temperature of the catalyst is progressively increased downstream by the reaction heat. Therefore, from the viewpoint of prevention of heat deterioration of the catalyst, in the case where a sweet shift catalyst is used as the catalyst to be packed in the shift reactor for converting CO in a gas into CO₂ and H₂ by the shift reaction, as disclosed in the above-described Japanese Patent Nos. 2870929 and 3149561, a method in which the Fe—Cr based catalyst is used under the conditions that the CO concentration is high and the temperature elevation of a catalyst bed is increased by the reaction heat, and the Cu—Zn-based catalyst is used under the conditions that the CO concentration is low is the mainstream method.

On the other hand, a shift catalyst having sulfur resistance has been developed, and representative examples thereof include a Co—Mo-based catalyst which is described in JP-A-9-132784 and WO 2010/116531 as a catalyst to be used in a gasifier electricity generation equipment.

Such a catalyst does not exhibit CO shift activity if H₂S does not coexist in a product gas, and therefore is called “sour shift catalyst”.

The Co—Mo-based catalyst exhibits CO shift activity in a wide temperature range, but has a higher reaction initiation temperature as compared with the Cu—Zn-based catalyst. The shift reaction is more difficult to proceed as the temperature is higher from the viewpoint of chemical equilibrium, and therefore, the shift reaction is promoted by supplying steam in an excess amount relative to the amount of CO.

In a thermal power plant constituting a coal gasifier electricity generation plant, in general, as steam to be subjected to a shift reaction in a shift reactor, steam to be supplied to a steam turbine in the thermal power plant is partially extracted and used. Therefore, in order to suppress a decrease in efficiency of electricity generation of the coal gasifier electricity generation plant, it is necessary to decrease the steam supply to be subjected to the shift reaction.

As described above, since the shift reaction is an exothermic reaction, as the temperature is increased, the reactivity of the catalyst is decreased from the viewpoint of equilibrium, and therefore, an excess amount of steam is needed. Further, in a gas obtained by gasification of coal, CO is contained at about 60 vol %, and thus, due to an exothermic reaction, the temperature of the catalyst is significantly increased.

For example, in the case where the catalyst inlet temperature is set to 250° C., and steam is supplied in an amount twice the amount of CO at a molar ratio on a volume basis, when the reaction proceeds to equilibrium, the temperature is increased to about 500° C. Therefore, if the catalyst is exposed to a high temperature for a long time, there is a concern that sintering of the active components or the support of the catalyst may proceed to deteriorate the durability of the catalyst.

In a coal gasifier plant provided with a thermal power plant, in order to recover CO₂ while suppressing a decrease in the efficiency of the thermal power plant, it is effective that the amount of steam to be subjected to the shift reaction in the shift reactor is decreased. In order to decrease the steam supply, it is necessary to perform the shift reaction in the shift reactor at a low temperature from the viewpoint of equilibrium.

However, since a conventional sour shift catalyst to be used as the catalyst in the shift reactor has a higher reaction initiation temperature than a sweet shift catalyst (Cu—Zn-based catalyst), it is necessary to supply steam in the shift reaction at a stoichiometric ratio or more for allowing the shift reaction to proceed.

Further, if the reaction initiation temperature is high, when the shift reaction is allowed to proceed to equilibrium, the catalyst bed outlet temperature is increased, and therefore, the soundness of the catalyst in terms of heat resistance may be deteriorated.

Therefore, it is necessary to change the catalyst species to be packed with respect to each reactor in consideration of the heat resistance of the catalyst, or to improve the heat resistance of the catalyst.

### SUMMARY OF THE INVENTION

An object of the present invention is to provide a shift catalyst, a gas purification method for a coal gasifier plant, and a gas purification equipment of a coal gasifier plant, with which a decrease in the efficiency of a plant due to recovery of CO₂ in a product gas in a coal gasifier plant can be suppressed, and the soundness of the catalyst in terms of heat resistance can be maintained.

As a catalyst to achieve the above object, the shift catalyst according to the present invention is a shift catalyst, which promotes a shift reaction in which CO and H₂O in a product gas containing H₂S are reacted to each other and converted into CO₂ and H₂, wherein the catalyst includes at least Mo and Ni, and TiO₂ as an oxide for supporting these active components is used as a support.

As a gas purification method for a coal gasifier plant to achieve the above object, the gas purification method for a coal gasifier plant according to the present invention is a gas purification method for a coal gasifier plant including: a scrubbing step in which scrubbing is performed for a product gas produced by gasification of a carbon-containing solid fuel and containing at least CO and H₂S to remove water-soluble substances contained in the product gas; a CO shift step in which a CO shift reaction is performed such that CO contained in the product gas after undergoing the scrubbing step is reacted with steam using a shift catalyst packed in a shift reactor and converted into CO₂ and H₂; and a CO₂/H₂S recovery step in which CO₂ and H₂S contained in the product gas after undergoing the CO shift step are removed, wherein the CO shift step is constituted by a multistage shift reactor which includes two or more stages of shift reactors performing the CO shift reaction, and among the shift reactors, a shift reactor disposed on the upstream side is packed with a high temperature shift catalyst, and a shift reactor disposed on the downstream side is packed with a low temperature shift catalyst.

As a gas purification method for a coal gasifier plant to achieve the above object, further, the gas purification method according to the present invention is a gas purification method for a coal gasifier plant including: a scrubbing step in which scrubbing is performed for a product gas produced by gasification of a carbon-containing solid fuel and containing at least CO and H₂S to remove water-soluble substances contained in the product gas; a CO shift step in which a CO shift reaction is performed such that CO contained in the product gas after undergoing the scrubbing step is reacted with steam using a shift catalyst packed in a shift reactor and converted into CO₂ and H₂; and a CO₂/H₂S recovery step in which CO₂ and H₂S contained in the product gas after undergoing the CO shift step are removed, wherein the CO shift step is constituted by a multistage shift reactor which includes two or more stages of shift reactors performing the CO shift reaction, and among the shift reactors, a shift reactor disposed on the upstream side is packed with a high temperature shift catalyst, and a shift reactor disposed on the downstream side is packed with a low temperature shift catalyst, and the method further includes a CO₂ recycling step in which a part of purified CO₂ after undergoing the CO₂/H₂S recovery step is recycled by being supplied to the shift reactor disposed upstream of the shift step through a CO₂ recycling tube.

As a gas purification equipment to achieve the above object, the gas purification equipment of a coal gasifier plant according to the present invention is a gas purification equipment of a coal gasifier plant including: a water scrubber for performing scrubbing for a product gas produced by gasification of a carbon-containing solid fuel and containing at least CO and H₂S to remove water-soluble substances contained in the product gas; a CO shift reactor for performing a CO shift reaction such that CO contained in the product gas after performing scrubbing in the water scrubber is reacted with steam using a shift catalyst packed in a shift reactor and converted into CO₂ and H₂; and a CO₂/H₂S recovery device for removing CO₂ and H₂S contained in the product gas after performing the CO shift reaction in the CO shift reactor, wherein the CO shift reactor is constituted by a multistage shift reactor which includes two or more stages of shift reactors, and among the shift reactors, a shift reactor disposed on the upstream side is packed with a high temperature shift catalyst, and a shift reactor disposed on the downstream side is packed with a low temperature shift catalyst.

As a gas purification equipment to achieve the above object, further, the gas purification equipment of a coal gasifier plant according to the present invention is a gas purification equipment of a coal gasifier plant including: a water scrubber for performing scrubbing for a product gas produced by gasification of a carbon-containing solid fuel and containing at least CO and H₂S to remove water-soluble substances contained in the product gas; a CO shift reactor for performing a CO shift reaction such that CO contained in the product gas after performing scrubbing in the water scrubber is reacted with steam using a shift catalyst packed in a shift reactor and converted into CO₂ and H₂; and a CO₂/H₂S recovery device for removing CO₂ and H₂S contained in the product gas after performing the CO shift reaction in the CO shift reactor, wherein the CO shift reactor is constituted by a multistage shift reactor which includes two or more stages of shift reactors, and among the shift reactors, a shift reactor disposed on the upstream side is packed with a high temperature shift catalyst, and a shift reactor disposed on the downstream side is packed with a low temperature shift catalyst, and the equipment further includes a CO₂ recycling tube through which a part of CO₂ purified by removing CO₂ and H₂S contained in the product gas by the CO₂/H₂S recovery device is supplied upstream of the CO shift reactor to effect recycling.

According to the present invention, a shift catalyst, a gas purification method for a coal gasifier plant, and a gas purification equipment of a coal gasifier plant, with which a decrease in the efficiency of a plant due to recovery of CO₂ in a product gas in a coal gasifier plant can be suppressed, and the soundness of the catalyst in terms of heat resistance can be maintained can be realized.

### BRIEF DESCRIPTION OF THE DRAWINGS

FIG. 1 is a schematic flow diagram showing a gas purification system for a coal gasifier plant according to a first embodiment of the present invention.

FIG. 2 is a system structure diagram showing the structure of the gas purification system for a coal gasifier plant according to the first embodiment of the present invention shown in FIG. 1.

FIG. 3 is a characteristic diagram showing the results obtained by calculating the correlation between the H₂O/CO ratio and the inlet temperature of a third shift reactor in the gas purification system for a coal gasifier plant according to the first embodiment through equilibrium calculation.

FIG. 4 is a system structure diagram showing the structure of a gas purification system for a coal gasifier plant according to a second embodiment of the present invention.

FIG. 5 is a characteristic diagram showing the results obtained by calculating the correlation between the CO/CO₂ ratio and the inlet temperature of a first shift reactor in the gas purification system for a coal gasifier plant according to the second embodiment through equilibrium calculation.

FIG. 6 is a diagram of a test device for testing a catalyst according to a third embodiment of the present invention.

FIG. 7 is a temperature characteristic diagram of each catalyst species showing the results of Test Example 1 in which the catalyst according to the third embodiment was tested.

FIG. 8 is a characteristic diagram showing the results of Test Example 2 in which the catalyst according to the third embodiment was tested and indicating the Mo/Ti ratio dependency.

FIG. 9 is a characteristic diagram showing the results of Test Example 3 in which the catalyst according to the third embodiment was tested and indicating the Ni/Mo ratio and the initial activity at 200° C.

FIG. 10 is a characteristic diagram showing the results of Test Example 3 in which the catalyst according to the third embodiment was tested and indicating the relationship between the Ni/Mo ratio and heat resistance.

FIG. 11 is a characteristic diagram showing the results of Test Example 4 in which the catalyst according to the third embodiment was tested and indicating the effect of addition of vanadium.

### DESCRIPTION OF THE PREFERRED EMBODIMENTS

Hereinafter, a shift catalyst, a gas purification method for a coal gasifier plant, and a gas purification equipment of a coal gasifier plant according to embodiments of the present invention will be described with reference to the accompanying drawings.

### First Embodiment

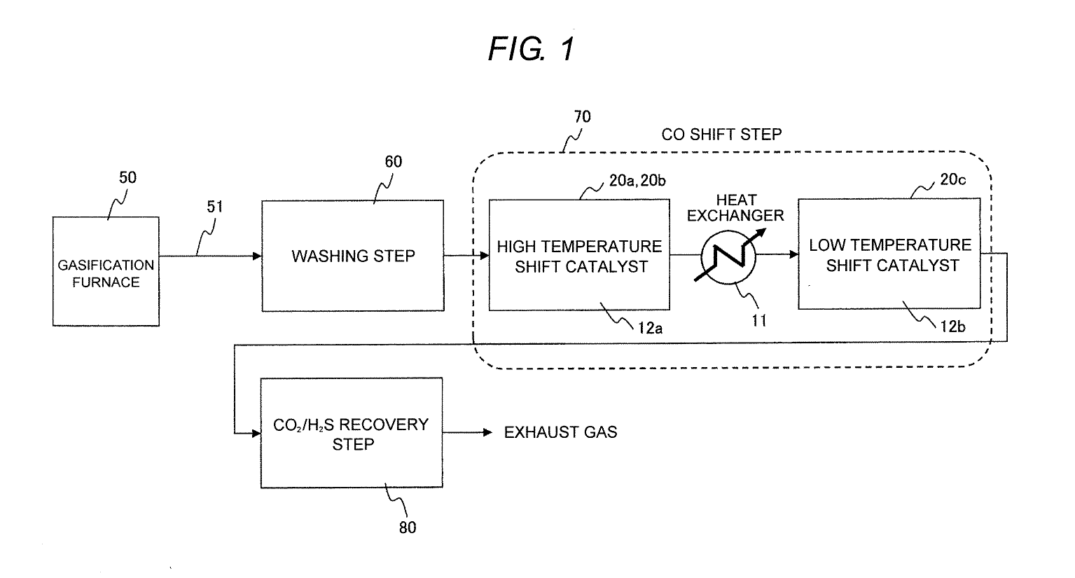

A shift catalyst, a gas purification method for a coal gasifier plant, and a gas purification equipment of a coal gasifier plant according to a first embodiment of the present invention will be described with reference to FIGS. 1 to 3.

FIG. 1 shows a schematic flow diagram of a gas purification system for a coal gasifier plant according to a first embodiment of the present invention. In the schematic flow diagram of a gas purification system for a coal gasifier plant according to this embodiment shown in FIG. 1, since water-soluble substances such as a hydrogen halide and ammonia are contained in a product gas 51 which is a coal gas obtained by gasification of coal in a gasifier 50 for gasifying coal, the product gas 51 is scrubbed in a scrubbing step 60 provided downstream of the gasifier 50.

Thereafter, the product gas 51 scrubbed in the scrubbing step 60 is supplied to a CO shift step 70 provided downstream of the scrubbing step 60, and in this CO shift step 70, CO contained in the product gas 51 is converted into CO₂ and H₂ by a shift reaction represented by the above-described formula (1). The CO shift step 70 has a multistage structure provided with a multistage shift reactor 20 including at least two stages of reactors, and for example, two stages of shift reactors 20a and 20b disposed on the upstream side are packed with a high temperature shift catalyst 12a.

Since CO is contained at about 60 vol % in the product gas 51, the temperature is increased at the outlet of each shift reactor performing this CO shift step 70.

Therefore, in the CO shift step 70, a heat exchanger 11 is provided between each of a plurality of shift reactors 20a, 20b, and 20c, and the product gas 51 whose temperature has been increased is cooled before the product gas 51 flows in the shift reactor disposed on the downstream side from the shift reactor disposed on the upstream side.

In the shift reactor 20c in the final stage, a low temperature shift catalyst 12b is packed. Since most of the CO contained in the product gas 51 is consumed in the shift reactors 20a and 20b disposed on the upstream side of the shift reactor 20c in the final stage, heat generation by the shift reaction is reduced in the shift reactor 20c in the final stage.

Incidentally, in order to convert CO at a low concentration into CO₂ at high efficiency, it is preferred to initiate the reaction at a low temperature from the viewpoint of equilibrium, and therefore, it is necessary to decrease the catalyst inlet temperature of the shift reactor 20c in the final stage as compared with the shift reactors 20a and 20b disposed on the upstream side.

Then, the product gas 51 after undergoing the CO shift step 70 is supplied to a CO₂/H₂S recovery step 80 disposed on the downstream side, and then discharged to the outside of the system after recovering CO₂ and H₂S contained in the product gas 51.

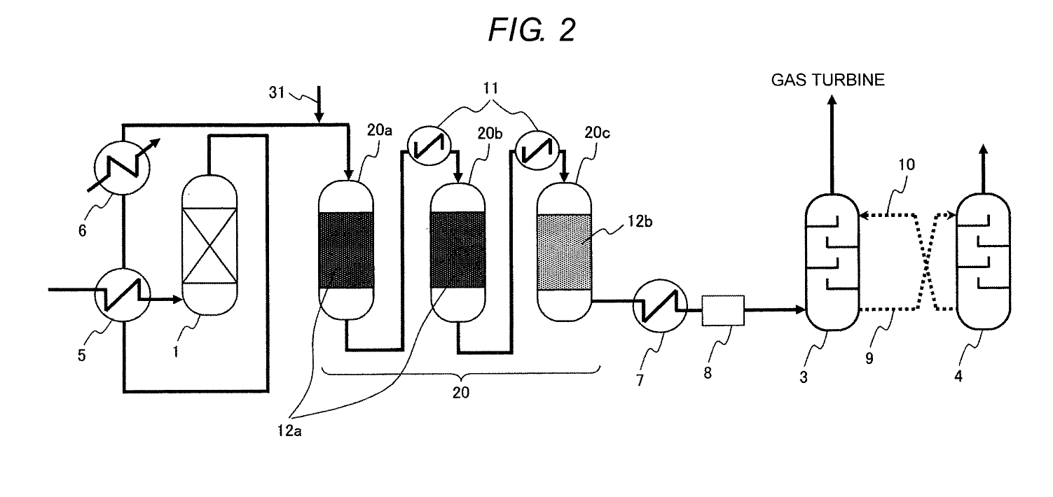

Next, in FIG. 2, the structure diagram of the gas purification system for a coal gasifier plant according to the first embodiment of the present invention shown in FIG. 1 is shown.

The gas purification system for a coal gasifier plant according to this embodiment shown in FIG. 2 is provided with: as main constituent devices, a water scrubber 1 in which a product gas 51 of a coal gas produced by gasification of coal in a gasifier 50 is introduced after passing through a heat exchanger 5 to scrub away water-soluble substances such as a hydrogen halide and ammonia contained in the product gas 51; shift reactors 20a, 20b, and 20c in which CO contained in the product gas 51 which is scrubbed in the water scrubber 1 and heated by the heat exchanger 5 and a gas heater 6 is converted into CO₂ and H₂ by a shift reaction represented by the above-described formula (1); and a H₂S/CO₂ simultaneous absorption tower 3, in which CO₂ and H₂S obtained by conversion in the shift reactors 20a, 20b, and 20c and contained in the product gas 51 are recovered, and a regeneration tower 4.

Among the plurality of shift reactors including the shift reactors 20a, 20b, and 20c, in the shift reactors 20a and 20b, a high temperature shift catalyst 12a is packed, and in the shift reactor 20c, a low temperature shift catalyst 12b is packed, and a shift reaction is performed in each of the shift reactors.

In the gas purification system for a coal gasifier plant according to this embodiment, the shift reactor has a three-stage structure including a first shift reactor 20a, a second shift reactor 20b, and a third shift reactor 20c, and the high temperature shift catalyst 12a is packed in each of the first shift reactor 20a in the first stage and the second shift reactor 20b in the second stage disposed on the downstream side of the first shift reactor 20a, and the low temperature shift catalyst 12b is packed in the third shift reactor 20c in the third stage disposed on the downstream side of the second shift reactor 20b.

In the H₂S/CO₂ simultaneous absorption tower 3, which is disposed on the downstream side of the third shift reactor 20c and recovers CO₂ and H₂S obtained by conversion in the shift reactors 20a, 20b, and 20c having the above-described structure and contained the product gas 51, H₂S and CO₂ from the product gas 51 are absorbed in an absorbent. Incidentally, the absorbent will be described later.

The product gas 51 produced in the gasifier 50 is passed through the heat exchanger 5 and then sent to the water scrubber 1 constituting the scrubbing step 6 shown in FIG. 1 and scrubbed. Specifically, by scrubbing the product gas 51 in the water scrubber 1, impurities such as a heavy metal and a hydrogen halide in the product gas 51 are removed.

Thereafter, the product gas 51 scrubbed in the water scrubber 1 is sent to the shift reactors 20a, 20b, and 20c constituting the CO shift step 70 shown in FIG. 1, and at this time, the product gas 51 scrubbed in the water scrubber 1 is heated by the heat exchanger 5 and the gas heater 6 so that the temperature is increased to the reaction temperature of the shift catalyst, and then, introduced into the shift reactors 20a, 20b, and 20c.

The temperature of the product gas 51 at the inlet of the shift reactor 20, to which the product gas 51 scrubbed in the water scrubber 1 is heated by the heat exchanger 5 and the gas heater 6, reaches 200° C. to 300° C. Incidentally, the reason why the product gas 51 is heated to 200° C. to 300° C. will be described later.

The main components of the product gas 51 at the inlet of the shift reactor 20 during steady operation are CO and H₂, and CO is contained at about 60 vol % in a dry state, and H₂ is contained at about 25 vol %.

By supplying steam 31 at a high temperature on the inlet side of the shift reactor 20a to the product gas 51, a CO shift reaction proceeds by the shift catalyst in the shift reactors 20a, 20b, and 20c.

Further, the product gas 51 contains a small amount of COS.

COS is converted into CO₂ and H₂S by a reaction represented by the formula (2), however, the reaction is a lyolysis reaction in the same manner as the shift reaction, and therefore, proceeds by the same catalyst as the shift catalyst. Accordingly, a COS converter is not additionally provided, and by the above-described shift reactors 20a, 20b, and 20c, a small amount of COS contained in the product gas 51 is converted into CO₂ and H₂₅ by the shift reaction represented by the formula (2) in the same manner as CO.

COS+H₂O→CO₂+H₂S (2)

The product gas 51 after undergoing the CO shift reaction and the COS shift reaction in the shift reactors 20a, 20b, and 20c is discharged from the shift reactors 20a, 20b, and 20c, and cooled by a heat exchanger 7 provided on the downstream side of the third shift reactor 20c.

The moisture in the product gas 51 cooled by the heat exchanger 7 is condensed in a knockout drum 8 provided on the downstream side of the heat exchanger 7 and removed to the outside of the system.

Thereafter, the product gas 51 passing through the knockout drum 8 is sent to the H₂S/CO₂ simultaneous absorption tower 3 constituting the CO₂/H₂S recovery step 80, and H₂S and CO₂ in the product gas 51 are removed by an absorbent.

At this time, H₂ which is not absorbed by the absorbent is discharged from the H₂S/CO₂ simultaneous absorption tower 3, and supplied to a gas turbine constituting a thermal power plant provided in the gas purification system for a coal gasifier plant according to this embodiment as a fuel and combusted therein.

The absorbent (rich liquid) absorbing H₂S and CO₂ in the product gas 51 in the H₂S/CO₂ simultaneous absorption tower 3 is sent to the regeneration tower 4 disposed on the downstream side of the H₂S/CO₂ simultaneous absorption tower 3 through a rich liquid channel 9 and regenerated by heating.

H₂S discharged to the outside of the system after regeneration by heating in the regeneration tower 4 is converted into gypsum by a calcium-based absorbent, and CO₂ is recovered by liquefaction and solidification.

Further, the absorbent (lean liquid) regenerated in the regeneration tower 4 is sent to the H₂S/CO₂ simultaneous absorption tower 3 from the regeneration tower 4 through a lean liquid channel 10 and used for absorbing H₂S and CO₂ in the product gas 51 in the H₂S/CO₂ simultaneous absorption tower 3.

In the gas purification system for a coal gasifier plant according to this embodiment, the water scrubber 1 is provided on the upstream side of the shift reactors 20a, 20b, and 20c, and a heavy metal and a hydrogen halide in the product gas 51 are removed.

The catalysts to be used in the shift reactors 20a, 20b, and 20c may be poisoned by the inflow of a heavy metal or a hydrogen halide to decrease the activity. Therefore, the water scrubber 1 is provided on the upstream side of the shift reactors 20a, 20b, and 20c to remove a heavy metal or a hydrogen halide in the product gas 51.

Incidentally, in this embodiment, an example in which as the device for removing a heavy metal or a hydrogen halide in the product gas 51, the water scrubber 1 which is a wet-type removing device is used is shown, however, a dry-type removing device using an adsorbent or an absorbent may be used.

As the adsorbent or the absorbent for removing a heavy metal or a hydrogen halide in the product gas 51 in the case of using a dry-type removing device, other than an oxide, a carbonate, or a hydroxide of an alkali metal or an alkaline earth metal, a porous material such as active carbon or zeolite can be used.

By using a dry-type removing device, a cooling or heating operation for the product gas 51 can be omitted, and therefore, energy loss can be suppressed.

Incidentally, when the water scrubber 1 is used, it is expected that accompanying steam from the water scrubber 1 may be mixed in the product gas, and there is also an advantage that the amount of steam to be supplied at the inlet of the first shift reactor 20a can be reduced.

As the catalyst to be packed in the shift reactors 20a, 20b, and 20c, a Ni/Mo-based catalyst, which will be described later, is preferred from the viewpoint of shift ratio, and for example, as the high temperature shift catalyst 12a, a Co/Mo/Al₂O₃-based catalyst, which is a common sour shift catalyst, can also be used. Further, other than this, any catalyst can be used as long as it is a shift catalyst having sulfur resistance.

The shift reaction is a lyolysis reaction as shown in the formula (1), and therefore, a steam supply tube is provided upstream of the first shift reactor 20a so that a predetermined amount of steam 31 can be constantly supplied to the product gas 51.

As the H₂S/CO₂ simultaneous absorption tower 3, either a physical absorption tower or a chemical absorption tower can be applied. The structure of the H₂S/CO₂ simultaneous absorption tower 3 may be the same as that of a conventional CO₂ absorption tower, and by using one type of absorbent, H₂S and CO₂ are absorbed.

As an example of the absorbent, in the case of physical absorption, Selexol, Rectisol, or the like can be used, and in the case of chemical absorption, methyl diethanolamine (MDEA), ammonia, or the like can be used.

In the gas purification system for a coal gasifier plant according to this embodiment, the absorbent absorbing H₂S and CO₂ contained in the product gas 51 in the H₂S/CO₂ simultaneous absorption tower 3 is sent to the regeneration tower 4 disposed on the downstream side of the H₂S/CO₂ simultaneous absorption tower 3 through the rich liquid channel 9 from the H₂S/CO₂ simultaneous absorption tower 3, and regenerated by heating.

In the regeneration of the absorbent, other than a system using the regeneration tower 4, a flash regeneration system using pressure swing or a regeneration system combining flash regeneration with regeneration using a regeneration tower may be adopted.

In the case of using flash regeneration, H₂S and CO₂ can be separated and recovered from the product gas 51, and high-purity CO₂ can be recovered.

In the gas purification system for a coal gasifier plant according to this embodiment, the relationship between the inlet temperature of the third shift reactor 20c which is the shift reactor in the final stage in the shift reactor having a multistage structure including the shift reactors 20a, 20b, and 20c and the H₂O/CO ratio which is an index of the steam supply of the steam 31 is shown, and the importance of the inlet temperature of the third shift reactor 20c which is the shift reactor in the final stage will be described.

The structure of the shift reactor having a multistage structure including the shift reactors 20a, 20b, and 20c is a three-stage structure in the same manner as a gas purification system for a coal gasifier plant according to a second embodiment, and the gas composition in the product gas 51 is set as follows: CO: 55 vol %, H₂: 20 vol %, CO₂: 11 vol %, CH₄: 1 vol %, and N₂: 13 vol %.

The inlet temperature of the first shift reactor 20a and the second shift reactor 20b was set to 250° C., and when the steam amount (H₂O/CO ratio) of the steam 31 to be supplied to the first shift reactor 20a was changed, the inlet temperature of the third shift reactor 20c required for obtaining a CO conversion of 95% calculated based on the formula (3) in the three shift reactors 20a, 20b, and 20c was calculated through equilibrium calculation.

CO conversion=(1−outlet CO concentration)/(inlet CO concentration))×100 (3)

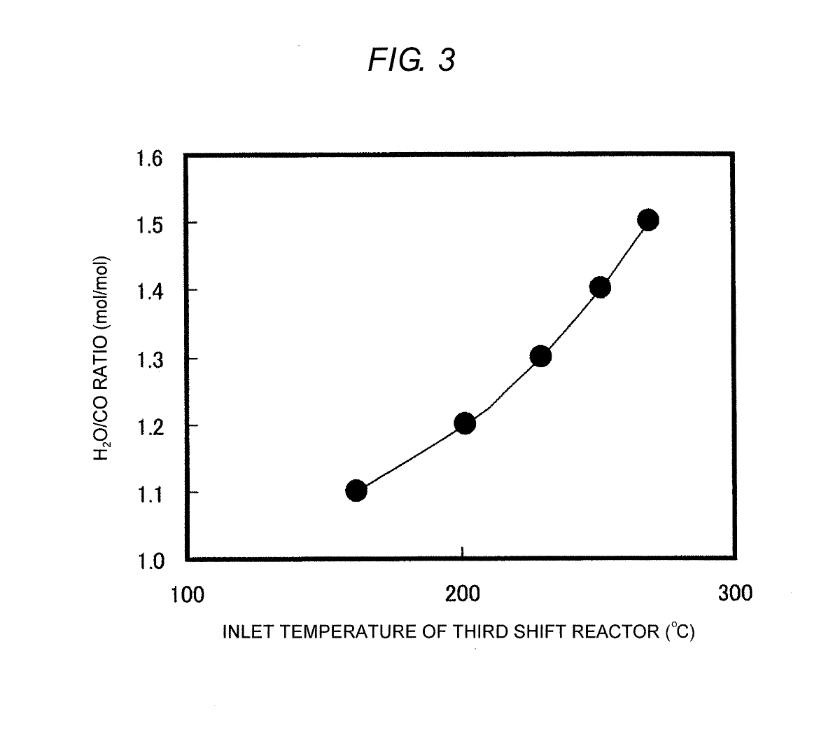

The calculation results obtained by calculating the relationship between the inlet temperature of the third shift reactor 20c calculated through equilibrium calculation based on the formula (3) and the steam amount (H₂O/CO ratio) are shown in FIG. 3.

As shown in FIG. 3, it was found that as the inlet temperature of the third shift reactor 20c is decreased, the steam amount (H₂O/CO ratio) capable of achieving a CO conversion of 95% is decreased. For example, by setting the inlet temperature of the third shift reactor 20c to about 200° C., a CO conversion of 95% can be achieved, and the H₂O/CO ratio can be decreased to 1.2.

In the case where H₂O/CO ratio is set to 1.2, and as the catalysts packed in the first shift reactor 20a, the second shift reactor 20b, and the third shift reactor 20c, the high temperature shift catalyst 12a is used in all the three reactors (the inlet temperature of the first shift reactor 20a, the second shift reactor 20b, and the third shift reactor 20c was set to 250° C.), only a CO conversion up to 92% is obtained, and a CO conversion of 95% cannot be achieved.

That is, by decreasing the inlet temperature of the third shift reactor 20c, for example, the steam amount to be used in the shift reaction can be decreased, and therefore, it becomes possible to suppress a decrease in the efficiency of the coal gasifier plant.

Accordingly, it was found that by decreasing only the inlet temperature of the third shift reactor 20c which is the shift reactor in the final stage, the steam amount (H₂O/CO ratio) capable of achieving a CO conversion of 95% can be decreased.

According to the gas purification system for a coal gasifier plant of this embodiment, an advantage of operating only the third shift reactor 20c in the final stage at a low temperature can be demonstrated. Therefore, an operation method in which in the first shift reactor 20a and the second shift reactor 20b other than the third shift reactor 20c in the final stage, the high temperature shift catalyst 12a having little lower activity, but having heat resistance, is packed to decrease CO in the reaction gas, and by decreasing the inlet temperature of the third shift reactor 20c in the final stage and supplying a small amount of steam, a high CO conversion is obtained can be obtained.

According to this embodiment described above, a gas purification method and a gas purification equipment of a coal gasifier plant, with which a decrease in the efficiency of the plant by recovery of CO₂ in the product gas in the coal gasifier plant can be suppressed, and the soundness of the catalyst in terms of heat resistance can be maintained can be realized.

### Second Embodiment

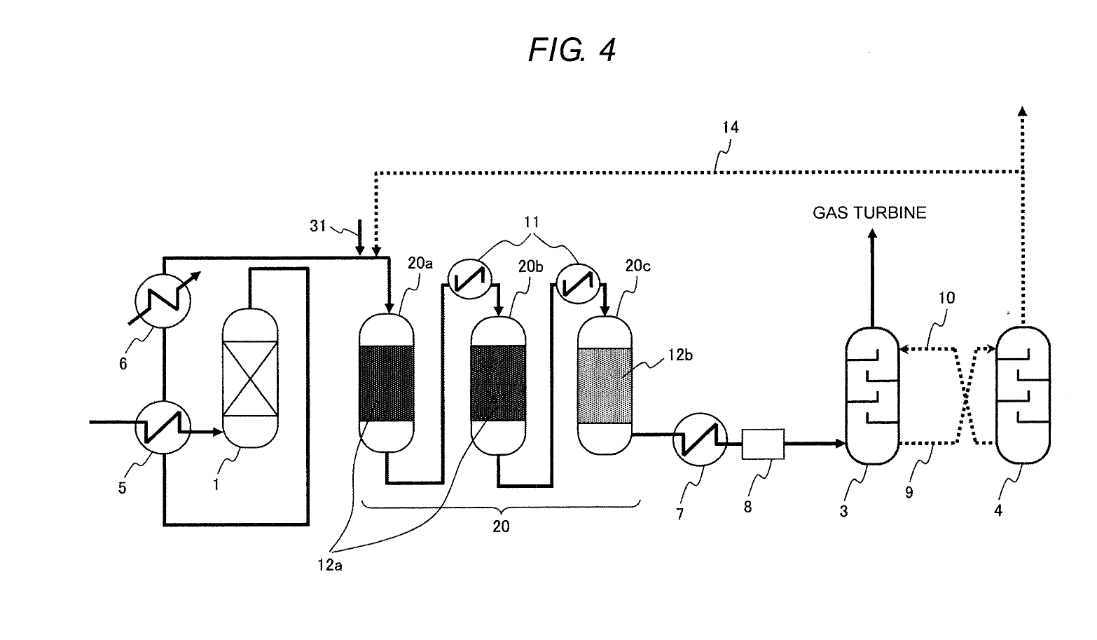

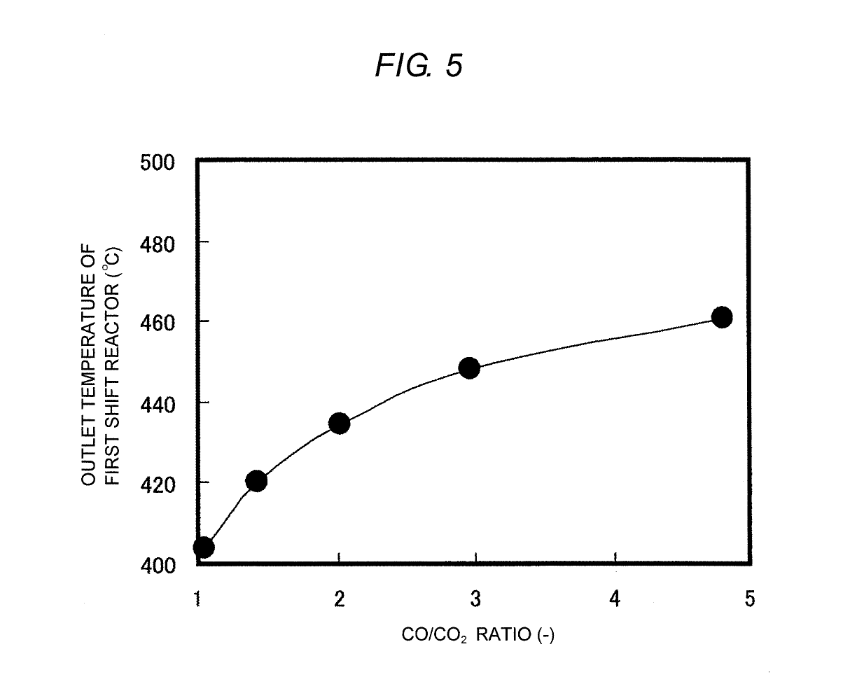

Next, a gas purification method and a gas purification equipment of a coal gasifier plant according to a second embodiment of the present invention will be described with reference to FIGS. 4 and 5.

Since the basic structure of the gas purification system for a coal gasifier plant according to the second embodiment of the present invention shown in FIG. 4 is in common with that of the gas purification system for a coal gasifier plant according to the first embodiment shown in FIG. 2, description of the structure common in both embodiments is omitted, and only different parts will be described below.

In the gas purification system for a coal gasifier plant according to this embodiment shown in FIG. 4, what is different from the gas purification system for a coal gasifier plant according to the first embodiment is that a CO₂ recycling tube 14 for returning a part of CO₂ discharged from the regeneration tower 4 to the upstream of the first shift reactor 20a is provided, and a CO₂ recycling step in which a part of CO₂ is supplied to the shift reactor 20a upstream of the above-described shift step through the CO₂ recycling tube 14 and recycled is provided.

The purpose of providing the CO₂ recycling tube 14 is to supply a part of CO₂ which is a substance produced by the shift reaction in the shift reactors 20a, 20b, and 20c to the first shift reactor 20a so that the shift reaction in the first shift reactor 20a is controlled and the equilibrium temperature is kept lower.

The operational effect in the gas purification system for a coal gasifier plant according to this embodiment is shown in FIG. 5.

That is, the calculation results obtained by calculating the relationship between the outlet temperature of the first shift reactor 20a and the ratio of CO to CO₂ (CO/CO₂ ratio) when the H₂O/CO ratio calculated by equilibrium calculation based on the formula (1) is 1.8 are shown in FIG. 5.

FIG. 5 shows the results of the operational effect obtained by trial calculation through equilibrium calculation of the outlet temperature of the first shift reactor 20a in the case where the H₂O/CO ratio was 1.8 when the ratio of CO to CO₂ (CO/CO₂ (vol %/vol %)) was changed in the gas composition of the product gas 51 used in the trial calculation in the first embodiment described above.

Incidentally, the inlet temperature of the first shift reactor 20a was set to 250° C. It was found that as the percentage of CO₂ is increased (the CO/CO₂ ratio is decreased), the outlet temperature of the first shift reactor 20a is decreased, and when CO₂ is recycled until the CO/CO₂ ratio is decreased to about 1, the outlet temperature of the first shift reactor 20a is decreased to 400° C.

It was found that according to the gas purification system for a coal gasifier plant of this embodiment, by providing the CO₂ recycling tube 14 at the inlet of the first shift reactor 20a, the shift reaction in the first shift reactor 20a can be controlled and the outlet temperature of the first shift reactor 20a can be decreased.

However, this method also has problems that in order to obtain a predetermined CO conversion, a large amount of the catalyst is required, in order to suppress the thermal deterioration of the catalyst, the inlet temperature of the third shift reactor 20c in the final stage is further decreased as compared with the conventional method, etc., and therefore, it is necessary to determine as to whether or not this method can be implemented in consideration of the intended CO conversion, initial cost, and so on.

According to this embodiment described above, a gas purification method and a gas purification equipment of a coal gasifier plant, with which a decrease in the efficiency of the coal gasifier plant by recovery of CO₂ in the product gas in the coal gasifier plant can be suppressed, and the soundness of the catalyst in terms of heat resistance can be maintained can be realized.

### Third Embodiment

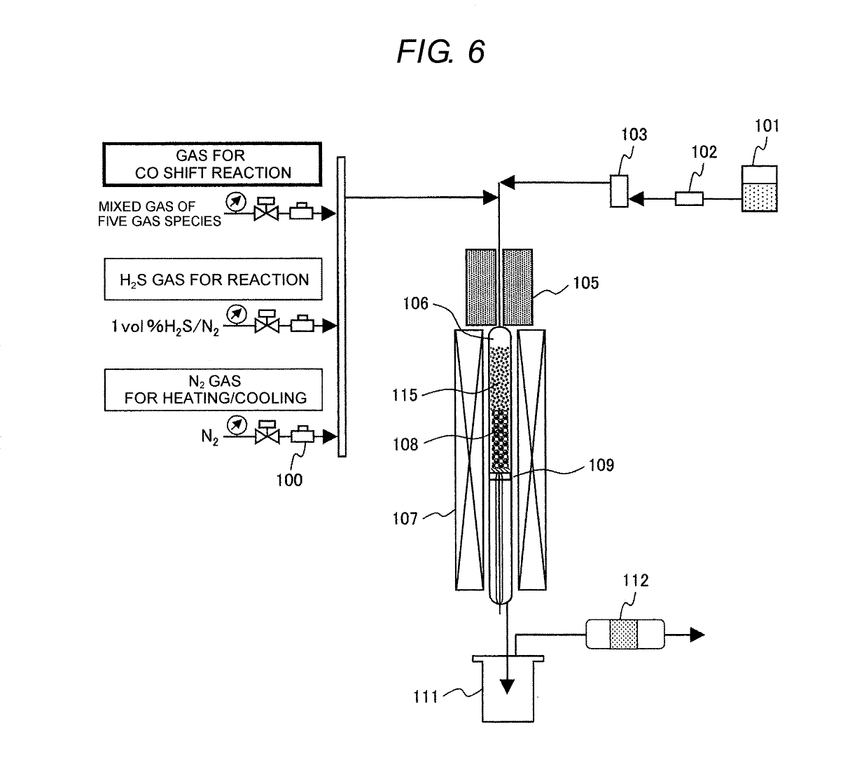

Next, a shift catalyst according to a third embodiment of the present invention to be used in a gas purification system for a coal gasifier plant will be described with reference to FIGS. 6 to 11 and Table 1.

With respect to the shift catalyst according to the third embodiment of the present invention, which converts CO in a product gas obtained by gasification of coal in the presence of H₂S into CO₂, test examples showing the operational effect of the catalyst in the case where it is packed as the catalyst in the first shift reactor 20a, the second shift reactor 20b, and the third shift reactor 20c in the gas purification systems for a coal gasifier plant according to the first and second embodiments of the present invention will be described below.

In this test example, a fixed bed reactor was used for screening a catalyst packed in the first shift reactor 20a, the second shift reactor 20b, and the third shift reactor 20c used in the gas purification systems for a coal gasifier plant according to the present embodiments described above. The schematic diagram of this fixed bed reactor is shown in FIG. 6.

In the fixed bed reactor shown in FIG. 6, the basic structure of this fixed bed reactor includes a mass flow controller 100 constituting a gas supply system, a water tank 101, a plunger pump 102, and a water vaporizer 103 constituting a steam supply system, a mantle heater 105, a reaction tube 106, an electric furnace 107, and a trapping vessel 111. The reaction temperature in the reaction tube 104 was changed by the electric furnace 107.

In the trapping vessel 111, the moisture in the gas is condensed and trapped, and thereafter, the moisture in the gas is completely removed by a moisture absorption device 112 packed with magnesium perchlorate.

As the reaction gas that imitates the product gas, CO, H₂, CH₄, CO₂, N₂ and H₂S were supplied to the reaction tube 106 by adjusting the flow rate by the mass flow controller 100 to a predetermined flow rate. Further, the steam is supplied to the reaction tube 106 by adjusting the flow rate of water in the water tank 101 by the plunger pump 102 and then vaporizing the water by the water vaporizer 103.

In the reaction tube 106, a perforated plate is provided, and glass wool 109 is placed on the perforated plate, and a test catalyst 108 is packed on the upper portion of the glass wool. Further, on the upper portion of the test catalyst 108, a Raschig ring 115 is packed as a rectifying material.

The test conditions for evaluating the performance of the test catalyst 108 were set as follows. A sour shift catalyst is packed in the reaction tube 106 in an oxide state, and therefore, when it is used, it is necessary to reduce Mo by a sulfurization and reduction operation represented by the reaction formula (4).

MoO₃+2H₂S+H₂→MOS₂+3H₂O (4)

While allowing the reaction gas N₂ to flow through the reaction tube 106, the temperature of the test catalyst 108 was increased to 180° C. Thereafter, the reaction gas was changed to 7 volt H₂/N₂ gas and allowed to flow through the reaction tube 106, and the temperature was increased to 200° C. After the temperature became stable, the concentration of the reaction gas H₂S was adjusted to 3 vol % and supplied to the reaction tube 106.

After confirming that the reaction gas H₂S was detected at the outlet of the catalyst bed of the test catalyst 108, the temperature of the test catalyst 108 was increased to 320° C. at 1° C./min, and maintained at 320° C. for 45 minutes, and then, the sulfurization and reduction treatment was completed.

As the test gas, a mixed gas of five gas species (CO: 60 vol %, H₂: 20 vol %, CO₂: 5 vol %, CH₄: 1 vol %, N₂: 14 vol %) and 1% H₂S/N₂ balance gas were used.

As for the catalyst packing amount of the test catalyst 108, the catalyst was packed so that the wet gas hourly space velocity (SV) was 10,000 h⁻¹.

Further, H₂O which is a reactant was supplied by adjusting so that the H₂O/CO (molar ratio) was 1.8. Sampling of the gas at the outlet of the catalyst bed of the test catalyst 108 was performed, and the CO concentration was measured by gas chromatography. Then, the CO conversion was calculated according to the formula (5) in consideration of the flow rate of the gas.

CO conversion=1−(outlet CO flow rate)/(inlet CO flow rate)=1−((outlet CO concentration)×(outlet gas flow rate))/((inlet CO concentration)×(inlet gas flow rate)) (5)

Next, Test Examples 1 to 4 showing the operational effect of the catalyst in the case where the catalyst according to this embodiment was packed in the first shift reactor 20a, the second shift reactor 20b, and the third shift reactor 20c in the gas purification systems for a coal gasifier plant according to the first and second embodiments of the present invention will be described.

### Test Example 1

With respect to the test catalyst, which is the catalyst according to the present embodiment to be used as the catalyst in the shift reactor in the gas purification system for a coal gasifier plant according to the present embodiment described above, first, in Test Example 1, the temperature characteristics of a Co/Mo/Al₂O₃ catalyst and a Ni/Mo/TiO₂ catalyst were compared.

The preparation method for the test catalysts described above will be described. Both of the test catalysts were prepared by a kneading method.

As the starting materials of the Co/Mo/Al₂O₃ catalyst, pseudoboehmite (AlO(OH)₁/2H₂O, trade name: PURAL SB1, manufactured by Condair), ammonium heptamolybdate tetrahydrate (manufactured by Wako Pure Chemical Industries, Ltd.), and cobalt nitrate hexahydrate were used, and the catalyst was prepared such that the molar ratio of Co:Mo:Al was 0.05:0.05:1.

As the starting materials of the Ni/Mo/TiO₂ catalyst, titanium oxide (trade name: MC-150, manufactured by Ishihara Sangyo Kaisha, Ltd.), ammonium heptamolybdate tetrahydrate, and nickel nitrate hexahydrate were used, and the catalyst was prepared such that the molar ratio of Ni:Mo:Ti was 0.05:0.05:1.

Distilled water was added such that the amount of water including water in the hydrates was 40 g, and the resulting mixture was wet-kneaded in an automatic mortar for 30 minutes. Subsequently, the mixture was dried at 120° C. for 2 hours and then fired at 500° C. for 1 hour. After firing, the catalyst was crushed in a motor, and then molded by pressurizing at 500 kgf for 2 minutes by a press machine. At the end, the catalyst after molding was sized to 10 to 20 mesh, whereby the test catalyst was obtained.

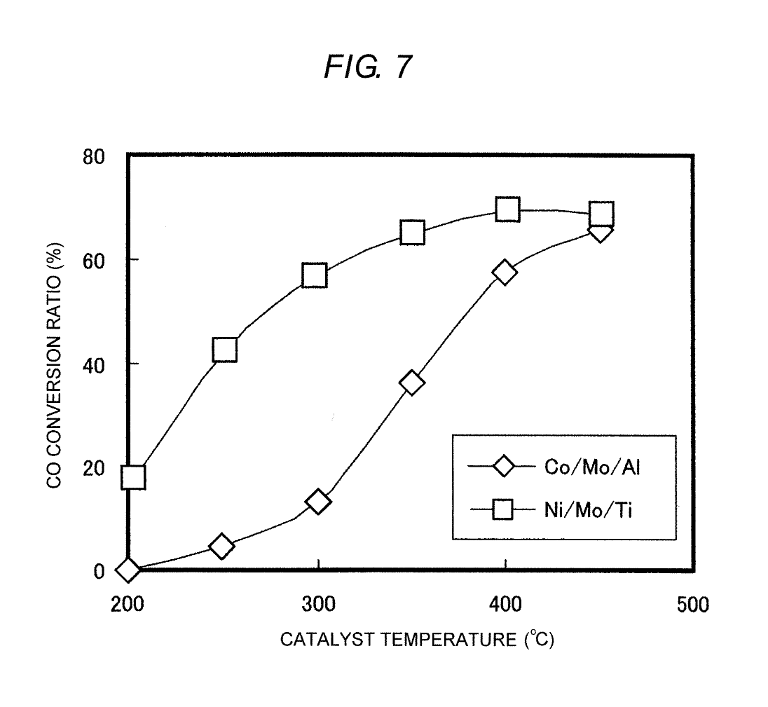

The temperature profile of each of the thus prepared catalysts is shown in FIG. 7. As shown in the characteristic diagram of the relationship between the catalyst temperature and the CO conversion in each of the test catalysts in Test Example 1 of the present embodiment in FIG. 7, in the case of the Co/Mo/Al₂O₃ catalyst, when the temperature was in a range of 300° C. or lower, the CO conversion was 20% or less, however, in the case of the Ni/Mo/TiO₂ catalyst, it was confirmed that even when the temperature was 250° C., a conversion of 400 or more was obtained, and thus the Ni/Mo/TiO₂ catalyst was found to have excellent low-temperature activity.

From the above results, it was found that a catalyst constituted by Ni/Mo/TiO₂ which is the catalyst according to the present embodiment exhibits high activity at a low temperature as the shift catalyst that promotes the shift reaction under the condition of coexistence of H₂S.

### Test Example 2

With respect to the test catalyst, which is the catalyst according to the present embodiment to be used as the catalyst in the shift reactor in the gas purification system for a coal gasifier plant according to the present embodiment described above, next, in Test Example 2, the compositional ratio of a Ni/Mo/TiO₂ catalyst was optimized. First, the addition amount of Mo relative to the amount of Ti was optimized in a Mo/TiO₂ catalyst.

The preparation method for the test catalysts described above will be described. All the test catalysts were prepared by a kneading method. To 40 g of titanium oxide (trade name: MC-150, manufactured by Ishihara Sangyo Kaisha, Ltd.), ammonium heptamolybdate tetrahydrate was added such that the molar ratio of Mo to Ti (Mo/Ti) was 0.025, 0.05, 0.1, 0.2, 0.3, or 0.5. Wet kneading was performed, respectively, and thereafter, the preparation was performed in the same manner as in Test Example 1.

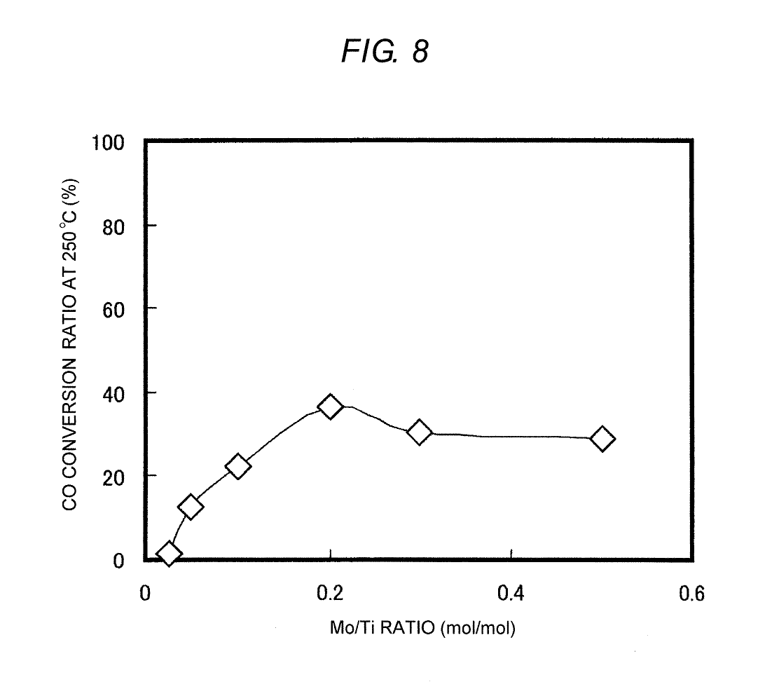

The correlation between the Mo/Ti ratio and the CO conversion when the test catalyst temperature was set to 250° C. is shown in FIG. 8. As shown in the characteristic diagram of the relationship between the Mo/Ti ratio and the CO conversion in the test catalyst in Test Example 2 of the present embodiment in FIG. 8, there was a tendency that the maximum CO conversion was obtained when the Mo/Ti ratio was 0.2.

The composition of the Mo/Ti ratio of 0.2 exhibiting the effect of improving the low-temperature activity, which is the object of the test catalyst, was determined as the optimal composition. If the Mo/Ti ratio is 0.05 or less, the CO conversion was 20% or less, and therefore, a sufficient conversion cannot be obtained. It is considered that if the Mo/Ti ratio is low, the amount of Mo serving as the active component is not sufficient, and thus, the CO conversion is low.

On the other hand, it is considered that if the Mo/Ti ratio is increased too much, the dispersibility of the Mo fine particles on the support is decreased to cause sintering during preparation, and thus, the active sites are decreased.

Accordingly, it is preferred to use a catalyst in which the Mo/Ti ratio is in a range of 0.2 to 0.5 in which a CO conversion is 20% or more.

### Test Example 3

With respect to the test catalyst, which is the catalyst according to the present embodiment to be used as the catalyst in the shift reactor in the gas purification system for a coal gasifier plant according to the present embodiment described above, next, in Test Example 3, the addition amount of Ni was optimized using the test catalyst having the composition of the Mo/Ti ratio of 0.2 optimized in Test Example 2 as a base.

The preparation method for the test catalysts described above will be described. All the test catalysts were prepared by a kneading method.

To 40 g of titanium oxide (trade name: MC-150, manufactured by Ishihara Sangyo Kaisha, Ltd.), ammonium heptamolybdate tetrahydrate and nickel nitrate hexahydrate were added such that the molar ratio of Mo, Ni, and Ti was 0.1:0.01:1, 0.1:0.015:1, 0.1:0.02:1, 0.1:0.025:1, or 0.1:0.05:1. Wet kneading was performed, respectively, and thereafter, the preparation was performed in the same manner as in Test Example 1.

Further, the heat resistance of each of the prepared catalysts was examined in this Test Example 3. The temperature characteristic of each of the above-described test catalysts was evaluated by increasing the catalyst inlet temperature by 50° C. from 200° C. to 450° C., and after completion of the test at 450° C., the performance of the catalyst at 200° C. was evaluated again. It is assumed that the shift reaction is a first-order reaction, and a reaction rate constant ratio (k/k₀) was calculated according to the formula (6) from the CO conversion at 200° C. before and after the temperature characteristic test and used as the index of the heat resistance.

k/k₀=(1−ln(activity after test))/(1−ln(initial activity)) (6)

With respect to the shift catalyst according to the third embodiment of the present invention, the test catalysts, for which the test was performed using the fixed bed reactor shown in FIG. 6, and the test results are shown in Table 1.

TABLE 1

| | | Compositional ratio | | | CO | | |
|---|---|---|---|---|---|---|---|
| | | (molar ratio) | | | conversion (%) | | |
| Catalyst No. | Ni/Mo | Ti | Mo | Ni | 200° C. | 300° C. | k/k0 |
| 1 | 0.1 | 1 | 0.1 | 0.01 | 8.3 | 32.9 | 1.00 |
| 2 | 0.125 | 1 | 0.1 | 0.0125 | 9.9 | 37.1 | 0.94 |
| 3 | 0.15 | 1 | 0.1 | 0.015 | 10.3 | 44 | 0.86 |
| 4 | 0.2 | 1 | 0.1 | 0.02 | 12.8 | 47.1 | 0.62 |
| 5 | 0.25 | 1 | 0.1 | 0.025 | 16.1 | 51.4 | 0.48 |
| 6 | 0.5 | 1 | 0.1 | 0.05 | 18.3 | 55.3 | 0.46 |

Table 1 shows the composition of each test catalyst subjected to the test for the catalyst according to the third embodiment of the present invention, and the test results including the CO conversion and the reaction rate constant ratio.

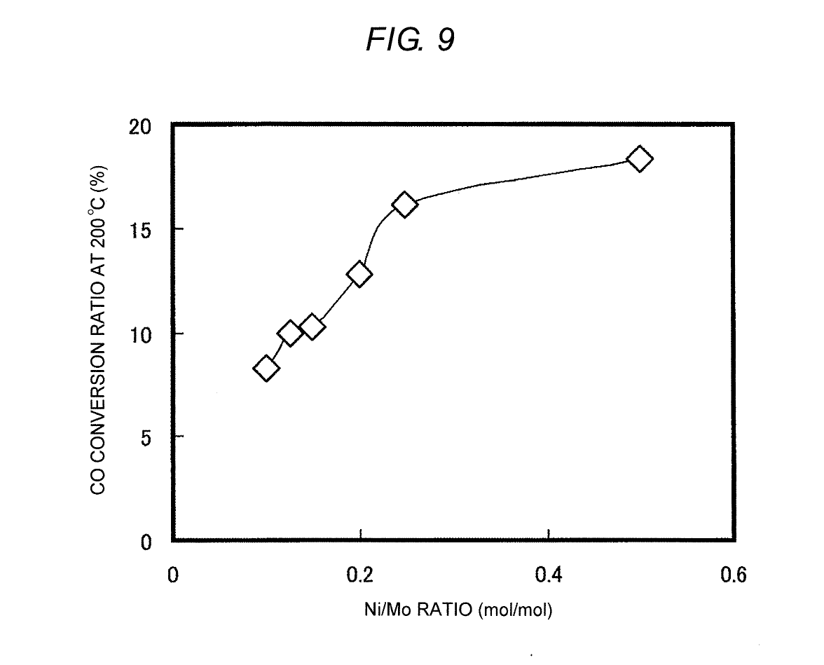

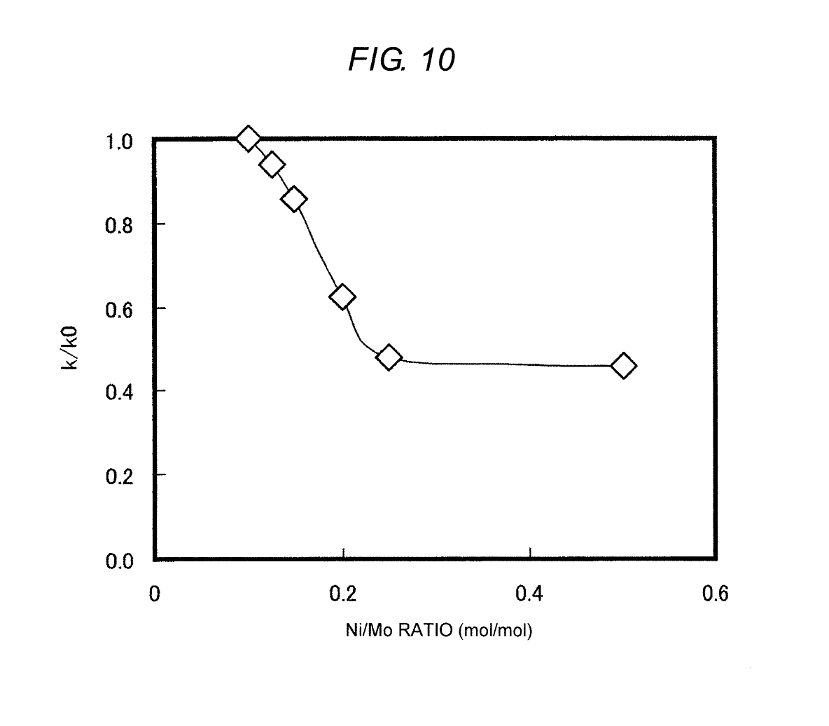

Further, the test results of the above-described temperature characteristic test are summarized in this Table 1, and the correlation between the initial CO conversion at 200° C. and the Ni/Mo ratio is shown in FIG. 9, and the correlation between the reaction rate constant ratio (k/k₀) and the Ni/Mo ratio is shown in FIG. 10.

As shown in the characteristic diagram of the relationship between the Ni/Mo ratio and the CO conversion in the test catalyst in Test Example 3 of the present embodiment in FIG. 9, as the Ni/Mo ratio is increased, the initial CO conversion is improved.

On the other hand, as shown in the characteristic diagram of the relationship between the Ni/Mo ratio and the reaction rate constant ratio (k/k₀) in the test catalyst in Test Example 3 of the present embodiment in FIG. 10, as the Ni/Mo ratio is increased, the reaction rate constant ratio (k/k₀) is decreased.

The reason why the performance of the CO conversion is improved as the Ni/Mo ratio is increased is presumed that the replacement of S in the catalyst and in the gas phase is promoted by an increment of Ni that supplements the replacement of S with Mo to improve the reaction rate.

On the other hand, the reason why the heat resistance expressed as the value of the reaction rate constant ratio (k/k₀) is decreased as the Ni/Mo ratio is increased is presumed that the dispersibility of Ni is decreased as Ni is increased, and sintering proceeds.

From the results shown in FIGS. 9 and 10, it was found that the initial activity and the heat resistance are in a trade-off relationship with respect to the Ni/Mo ratio.

Therefore, it is considered that a catalyst prepared at a compositional ratio such that the Ni/Mo ratio is less than 0.2 having high heat resistance can be used as a high temperature catalyst, and a catalyst prepared at a compositional ratio such that the Ni/Mo ratio is from 0.2 to 0.5 having high initial activity although having low heat resistance can be used as a low temperature catalyst.

### Test Example 4

With respect to the test catalyst, which is the catalyst according to the present embodiment to be used as the catalyst in the shift reactor in the gas purification system for a coal gasifier plant according to the present embodiment described above, next, in Test Example 4, the effect of the addition of V to a Ni/Mo/Ti catalyst in the test catalyst in terms of heat resistance was evaluated.

As the test catalyst used in this Test Example 4, a catalyst obtained by adding ammonium vanadate (manufactured by Wako Pure Chemical Industries, Ltd.) to a catalyst prepared at a compositional ratio of Ni:Mo:Ti=0.2:0.1:1 such that the molar ratio of V/Ti was 0.05 was used. As the preparation method, a kneading method was used. Wet kneading was performed, respectively, and thereafter, the preparation was performed in the same manner as in Test Example 1.

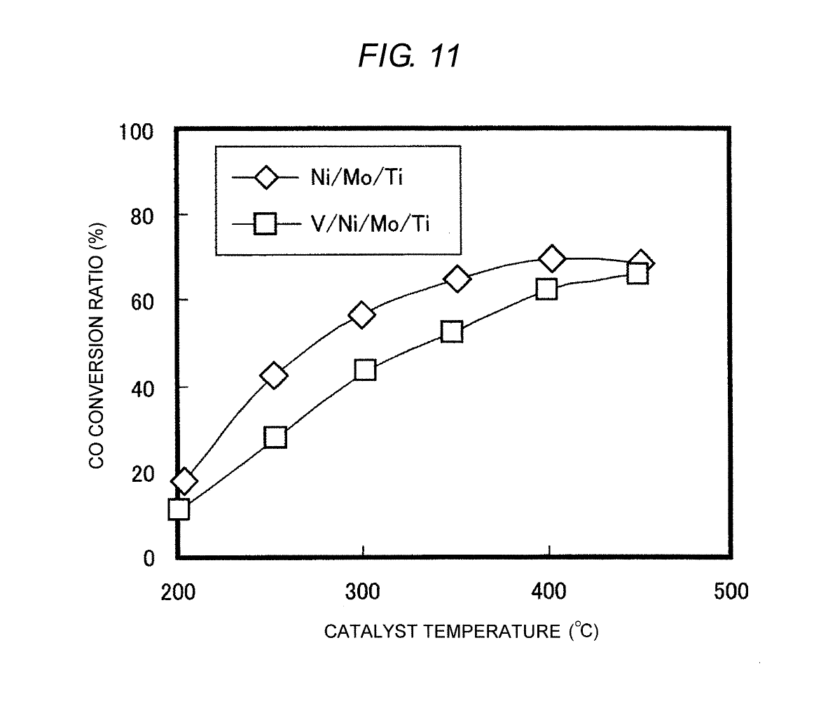

The temperature characteristics of the Ni/Mo/Ti test catalyst and the V/Ni/Mo/Ti test catalyst are shown FIG. 11. As shown in the characteristic diagram of the relationship between the catalyst temperature and the CO conversion in the test catalyst in Test Example 4 of the present embodiment in FIG. 11, it was found that the CO conversion at each temperature is decreased by the addition of V.

On the other hand, when the reaction rate constant ratio (k/k₀) was compared, in the case of the Ni/Mo/Ti test catalyst, the reaction rate constant ratio was 0.50, but in the case of the V/Ni/Mo/Ti test catalyst, the reaction rate constant ratio was 0.95, and thus, it was found that the heat resistance is improved by the addition of V.

It is considered that the effect of the addition of V is to maintain the structure of MoS₂ produced by the reduction and sulfurization treatment. In the Ni—Mo-based catalyst, after the reduction and sulfurization treatment, Ni—Mo—S is considered to exist while having a bridge structure. It is considered that V stabilizes the Ni—Mo—S structure and maintains the selectivity of the shift reaction.

As apparent from the test results of Test Examples 1 to 4 according to the present embodiment described above, a shift catalyst, with which a decrease in the efficiency of a coal gasifier plant due to recovery of CO₂ in a product gas in a coal gasifier plant can be suppressed, and the soundness of the catalyst in terms of heat resistance can be maintained, can be realized.

1. A shift catalyst, which promotes a shift reaction in which CO and H₂O in a product gas containing H₂S are reacted to each other and converted into CO₂ and H₂, wherein the catalyst comprises at least Mo and Ni, and TiO₂ as an oxide which supports these active components is used as a support.

2. The shift catalyst according to claim 1, wherein the shift catalyst further comprises vanadium (V).

3. The shift catalyst according to claim 1, wherein the molar ratio of the number of moles of Ni (Mb) to the number of moles of Mo (Ma) ((Mb)/(Ma)) in the shift catalyst is in a range of 0.2 to 0.5.

4. The shift catalyst according to claim 1, wherein the molar ratio of the number of moles of Mo (Ma) to the number of moles of Ti (Mc) in TiO₂ ((Ma)/(Mc)) in the shift catalyst is in a range of 0.1 to 0.5.

5. A gas purification method for a coal gasifier plant, comprising:
a scrubbing step in which scrubbing is performed for a product gas produced by gasification of a carbon-containing solid fuel and containing at least CO and H₂S to remove water-soluble substances contained in the product gas;
a CO shift step in which a CO shift reaction is performed such that CO contained in the product gas after undergoing the scrubbing step is reacted with steam using a shift catalyst packed in a shift reactor and converted into CO₂ and H₂; and
a CO₂/H₂S recovery step in which CO₂ and H₂S contained in the product gas after undergoing the CO shift step are removed, wherein
the CO shift step is constituted by a multistage shift reactor which includes two or more stages of shift reactors performing the CO shift reaction, and in the multistage shift reactor, a shift reactor disposed on the upstream side is packed with a high temperature shift catalyst, and a shift reactor disposed on the downstream side is packed with a low temperature shift catalyst.

6. The gas purification method for a coal gasifier plant according to claim 5, wherein in the CO shift step, a COS shift reaction is performed such that also COS contained in the product gas produced by gasification of coal is simultaneously reacted with steam and converted into CO₂ and H₂S using a shift catalyst packed in the shift reactor.

7.-9. (canceled)

10. A gas purification method for a coal gasifier plant, comprising:
a scrubbing step in which scrubbing is performed for a product gas produced by gasification of a carbon-containing solid fuel and containing at least CO and H₂S to remove water-soluble substances contained in the product gas;
a CO shift step in which a CO shift reaction is performed such that CO contained in the product gas after undergoing the scrubbing step is reacted with steam using a shift catalyst packed in a shift reactor and converted into CO₂ and H₂; and
a CO₂/H₂S recovery step in which CO₂ and H₂S contained in the product gas after undergoing the CO shift step are removed, wherein
the CO shift step is constituted by a multistage shift reactor which includes two or more stages of shift reactors performing the CO shift reaction, and among the shift reactors, a shift reactor disposed on the upstream side is packed with a high temperature shift catalyst, and a shift reactor disposed on the downstream side is packed with a low temperature shift catalyst, and
the method further comprises a CO₂ recycling step in which a part of purified CO₂ after undergoing the CO₂/H₂S recovery step is recycled by being supplied to the shift reactor disposed upstream of the shift step through a CO₂ recycling tube.

11. A gas purification equipment of a coal gasifier plant, comprising:
a water scrubber for performing scrubbing for a product gas produced by gasification of a carbon-containing solid fuel and containing at least CO and H₂S to remove water-soluble substances contained in the product gas;
a CO shift reactor for performing a CO shift reaction such that CO contained in the product gas after performing scrubbing in the water scrubber is reacted with steam using a shift catalyst packed in a shift reactor and converted into CO₂ and H₂; and
a CO₂/H₂S recovery device for removing CO₂ and H₂S contained in the product gas after performing the CO shift reaction in the CO shift reactor, wherein
the CO shift reactor is constituted by a multistage shift reactor which includes two or more stages of shift reactors, and among the shift reactors, a shift reactor disposed on the upstream side is packed with a high temperature shift catalyst, and a shift reactor disposed on the downstream side is packed with a low temperature shift catalyst.

12. (canceled)

13. A gas purification equipment of a coal gasifier plant, comprising:
a water scrubber for performing scrubbing for a product gas produced by gasification of a carbon-containing solid fuel and containing at least CO and H₂S to remove water-soluble substances contained in the product gas;
a CO shift reactor for performing a CO shift reaction such that CO contained in the product gas after performing scrubbing in the water scrubber is reacted with steam using a shift catalyst packed in a shift reactor and converted into CO₂ and H₂; and
a CO₂/H₂S recovery device for removing CO₂ and H₂S contained in the product gas after performing the CO shift reaction in the CO shift reactor, wherein
the CO shift reactor is constituted by a multistage shift reactor which includes two or more stages of shift reactors, and among the shift reactors, a shift reactor disposed on the upstream side is packed with a high temperature shift catalyst, and a shift reactor disposed on the downstream side is packed with a low temperature shift catalyst, and
the equipment further comprises a CO₂ recycling tube through which a part of CO₂ purified by removing CO₂ and H₂S contained in the product gas by the CO₂/H₂S recovery device is supplied upstream of the CO shift reactor to effect recycling.

14. (canceled)
